(19) United States
(12) Patent Application Publication
(10) Pub. No.: US 2020/0047654 A1
(43) Pub. Date: Feb. 13, 2020

(54) IMPROVED CONTROL SYSTEMS AND METHODS FOR THERMALLY CONDITIONED RECEPTACLES

(71) Applicant: GENTHERM INCORPORATED, Northville, MI (US)

(72) Inventors: Amanda Caroline Pine, Novi, MI (US); David Brian Marquette, Farmington Hills, MI (US); Andrew Philip Thomas Moehring, Dayton, OH (US)

(21) Appl. No.: 16/485,765

(22) PCT Filed: Feb. 15, 2018
(86) PCT No.: PCT/US2018/018305

§ 371 Date: Aug. 13, 2019

Related U.S. Application Data
(60) Provisional application No. 62/459,460, filed on Feb. 15, 2017.

(51) Int. Cl. B60N 3/10; A47J 36/24; F25D 29/00

(52) U.S. Cl. CPC B60N 3/104; F25D 2700/16; F25D 29/00; A47J 36/24

(57) ABSTRACT

Methods, systems, and related devices may partially or fully automatically control a thermal conditioning system of a thermally-conditioned receptacle in, for example, a vehicle. Selection of a method may be based on the presence and type of beverage detection sensors. Heating or cooling modes of operation may be based on historical preferences selected by the user, such as, for example, the selection of heating an item, such as a beverage container, when the first registration of the presence of the item in the receptacle occurs after system initiation. Heating or cooling modes of operation may be based on user input via one or more user input devices.

### CROSS-REFERENCE TO RELATED APPLICATIONS

This application claims priority to U.S. Provisional Application No. 62/459,460, filed Feb. 15, 2017, titled IMPROVED CONTROL SYSTEMS AND METHODS FOR BEVERAGE THERMAL CONDITIONING DEVICE, the entirety of which is hereby incorporated herein by reference in its entirety and made a part of this specification.

### BACKGROUND

### Field

This application relates to heating and cooling systems for thermally conditioned receptacles, such as, for example, beverage containers included in automobiles and other vehicles.

### Description of the Related Art

Most cars and other vehicles include one or more cup holders or bins which are configured to receive one or more cans, cups, bottles or other type of beverage containers. Recently, some vehicles have been provided with a thermal conditioning device for heating and cooling a beverage container (e.g. bottle, can, cup, etc.). The container can be used to store drinks and/or food at a temperature that is below or above the ambient temperature in the vehicle. Often, the container is heated and/or cooled by a heating and cooling system that includes a thermoelectric device (TED), which has a hot side and a cold side. A heat sink in the form of a waste side heat exchanger is thermally coupled to the hot side of the TED. A pump or fan is provided to promote convective heat transfer through the waste side heat exchanger. In some instances, the hot and/or cold side of the TED is conductively coupled to the container. In other instances, the hot and/or cool side of the TED is used to condition air, which, in turn, heats or cools the container through convection.

### SUMMARY

According to this disclosure a system for controlling operation of a thermally-conditioned receptacle can include one or more of the following: a control module configured to: detect an item within the receptacle; measure a temperature of the item within the receptacle; initiate a heating mode of operation in response to the measured temperature or a first user input; initiate a cooling mode of operation in response to the measured temperature or a second user input; and/or cancel the heating mode and the cooling mode of operation in response to a third user input.

According to this disclosure, the system can further include one or more of the following: the control module is further configured to determine whether detecting the item within the receptacle is a first detection of an item within the receptacle since a start up condition or the item was left within the receptacle before the start up condition; the control module is further configured to detect a door open signal and a key start signal and initiate the heating mode of operation in response to detection of the key start signal and the door open signal; initiating a heating mode of operation further comprises heating; the control module is further configured to detect a door open signal and a key start signal and initiate the cooling mode of operation in response to detection of the key start signal and the door open signal; and/or a graphical user interface configured to display cooling or heating mode of operation information to a user and accept the user inputs regarding cancellation or operation of the heating or cooling mode of operation.

According to this disclosure, a method for controlling operation of a thermally-conditioned receptacle can include one or more of the following: detecting an item within the receptacle; measuring a temperature of the item within the receptacle; accepting and storing a user input on a mode of operation; initiating a heating mode of operation or a cooling mode of operation in response to the measured temperature or the user input; and/or prompting a user confirmation of the initiated mode of operation.

According to this disclosure, the method can further include one or more of the following: initiating a heating mode of operation occurs in response to detection of a key start signal and a door open signal; initiating a heating mode of operation further comprises detecting whether an item has been removed from the receptacle, starting a timer, determining whether the item is redetected in the receptacle within a first time limit and when the item is redetected in the receptacle within the first time limit, resetting the timer and continuing to operate in the heating mode until otherwise prompted, and when the item is not redetected in the receptacle within the first time limit, initiating operation in a low power heating mode of operation; initiating a heating mode of operation further comprises detecting whether the item is redetected within the receptacle within a second time limit that is longer than the first time limit and prompting a user for confirmation or cancellation of the heating mode of operation; and/or operating the cooling mode for a predetermined time limit, measuring the temperature of the item after the predetermined time limit, determining whether the temperature of the item is above or below a predetermined temperature, displaying a message to a user if the temperature is below the predetermined temperature, and continuing operation of the cooling mode if the temperature is not below the predetermined temperature.

According to this disclosure, a system for controlling operation of a thermally-conditioned receptacle can include one or more of the following: a control module configured to: detect an item within the receptacle; receive a signal indicative of an operating condition of a vehicle; receive a user input on a desired mode of operation; initiate a heating mode of operation in response to the signal or the user input; initiate a cooling mode of operation in response to the signal or the user input; and/or cancel the heating mode and the cooling mode of operation in response to an other user input.

According to this disclosure, the system can further include one or more of the following: the signal is a key start signal; and/or the signal is a door open signal.

According to this disclosure, a method for controlling operation of a thermally-conditioned receptacle can include one or more of the following: detecting an item within the receptacle; receiving a first signal indicative of a door open condition; receiving a second signal indicative of a key start condition; accepting and storing a user input on a mode of operation; initiating a heating mode of operation or a cooling mode of operation in response to the first signal, the second signal, or the user input; and/or prompting a user confirmation of the initiated mode of operation.

According to this disclosure, the method can include one or more of following: initiating a heating mode of operation further comprises detecting whether an item has been removed from the receptacle, starting a timer, determining whether the item is redetected in the receptacle within a first time limit and when the item is redetected in the receptacle within the first time limit, resetting the timer and continuing to operate in a heating mode until otherwise prompted, and when the item is not redetected in the receptacle within the first time limit, initiating operation in a low power heating mode of operation; initiating a heating mode of operation further comprises detecting whether the item is redetected within the receptacle within a second time limit that is longer than the first time limit and prompting a user for confirmation or cancellation of the heating mode of operation; and/or operating the cooling mode for a predetermined time limit, measuring the temperature of the item after the predetermined time limit, determining whether the temperature of the item is above or below a predetermined temperature, displaying a message to a user if the temperature is below the predetermined temperature, and continuing operation of the cooling mode if the temperature is not below the predetermined temperature.

According to this disclosure, a method for controlling operation of a thermally-conditioned receptacle can include one or more of the following: detecting an item within the receptacle; determining whether item within the receptacle has been consumed; based on determining the item within the receptacle has not been consumed, initiating or continuing a heating mode of operation or a cooling mode of operation in response to a measured temperature (and/or other parameters, sensors, and/or inputs discussed herein) or a user input; and/or based on determining the item within the receptacle has been consumed, not initiating or discontinuing the heating mode of operation or the cooling mode of operation or prompting the user to confirm not initiating or discontinuing the heating mode of operation or the cooling mode of operation.

According to this disclosure, a system for controlling operation of a thermally-conditioned receptacle can include one or more of the following: a control module configured to: detect an item within the receptacle; determine whether item within the receptacle has been consumed; based on determining the item within the receptacle has not been consumed, initiate or continue a heating mode of operation or a cooling mode of operation in response to a measured temperature (and/or other parameters, sensors, and/or inputs discussed herein) or a user input; and/or based on determining the item within the receptacle has been consumed, not initiate or discontinue the heating mode of operation or the cooling mode of operation or prompt the user to confirm not initiating or discontinuing the heating mode of operation or the cooling mode of operation.

### BRIEF DESCRIPTION OF THE DRAWINGS

These and other features, aspects and advantages of the present application are described with reference to drawings of certain embodiments, which are intended to illustrate, but not to limit, the concepts disclosed herein. The attached drawings are provided for the purpose of illustrating concepts of at least some of the embodiments disclosed herein and may not be to scale.

FIG. 1 is a schematic illustration of a system for a thermally conditioned beverage container;

FIG. 2 is a block diagram illustration of a system implementing some operative elements of automatic control of heating and cooling a beverage container;

FIG. 3 is flowchart illustrating a control method for heating and/or cooling a beverage container according to some embodiments;

FIG. 4 is a flowchart illustrating a control method for heating and/or cooling a beverage container according to some embodiments;

FIG. 5 is a flowchart illustrating a control method for heating a beverage container according to some embodiments;

FIG. 6 is a flowchart illustrating a control method for cooling a beverage container according to some embodiments;

FIG. 7 is a flowchart illustrating a control method for heating and/or cooling a beverage container according to some embodiments;

FIG. 8 is a flowchart illustrating a graphical user interface system to control heating and/or cooling a beverage container according to some embodiments; and

FIG. 9 is a flowchart illustrating a graphical user interface system to control heating and/or cooling a beverage container according to some embodiments.

### DETAILED DESCRIPTION

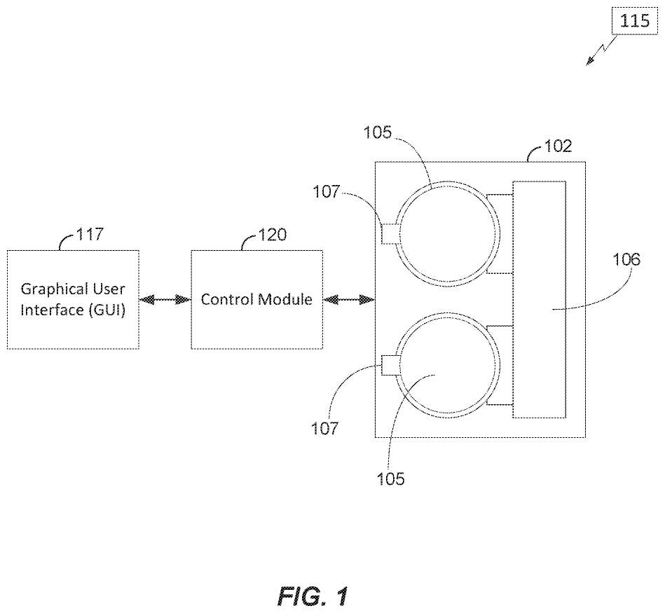

Embodiments of the inventive concepts disclosed herein relate to methods, as well as related devices and systems, for partially or fully automatically controlling a thermal conditioning system of a beverage receptacle for a vehicle, such as, for example, cup holder 102 as shown in FIG. 1. According to some embodiments, selection of a specific method may be based on the presence and type of beverage detection sensors, such as mechanical switches, pressure sensors, temperature sensors, other detection sensors, etc. within the beverage receptacle. For example, in some embodiments, one or more temperature sensors may be used to provide inputs indicative of the presence and/or temperature of a beverage container (e.g. bottle, can, cup, etc.) positioned within a receptacle or other portion of the climate controlled device or system. Such temperature sensors can help guide the choice of heating or cooling.

In some embodiments, the system is configured to, and is operable to, provide heating or cooling based on historical preferences selected by the user, such as, for example, the selection of heating a beverage when the first registration of the presence of a beverage container in the receptacle occurs after system initiation (e.g., once the car is started).

In some embodiments, the system may provide heating or cooling based on user input via one or more user input devices, such as, for example, a graphical user interface (GUI), another keypad, one or more buttons, switches or the like, etc.

In some embodiments, the system may automatically determine when a user has finished consuming a beverage and has placed the beverage container in the receptacle temporarily for storage until the beverage container can be properly disposed of in the trash. When the system determines the user has finished consuming the beverage, the system may automatically discontinue heating or cooling and/or prompt the user to confirm the user wishes to continue heating or cooling the beverage.

FIG. 1 schematically illustrates a thermal conditioning system 115 according to some embodiments. The system 115 includes, in some embodiments, a graphical user interface 117 and a control module 120, each of which may be operatively coupled to the cup holder 102. The cup holder 102 may include a plurality of beverage receptacles or thermally-conditioned receptacles 105, each of the beverage receptacles 105 configured to hold a beverage container. Each receptacle 105 may further include a beverage detection device 107. The beverage detection device 107 may be configured to determine the presence of a beverage container within the receptacle 105. The beverage detection device 107 may incorporate any known detection sensor such as mechanical switches, pressure sensors, temperature sensors, other detection sensors, etc. The cup holder 102 may further include a thermoelectric conditioning device or TED 106 configured to heat and/or cool the receptacles 105 of the cup holder 102.

In some embodiments, the control module 120 is housed together with the cup holder 102, while in other embodiments the cup holder 102 and the control module 120 are housed separately. For example, the control module 120 may be incorporated into the cup holder 102, forming a generally unitary structure. However, alternatively, the entirety or at least a portion of the control module 120 is separate from the receptacles or other portion of the cup or beverage holder 102. The thermal conditioning system 115 may be configured to, and be operable to, detect whether a cup or other beverage container has been placed in the cup holder or other beverage holder 102. Further, the system 115 can be adapted to selectively heat and/or cool the beverage based on user input, historical preferences, temperature detection, and/or any other factor or consideration, as desired or required.

According to some embodiments, the control module 120 is operatively coupled to the receptacle 102 for communicating information between the control module 120 and the cup holder 102. The coupling may be, for example, via a wired or wireless connection. Additionally, a graphical user interface (GUI) 117 or other user input and/or output device or system may, in some embodiments, be in communication with the control module 120. The GUI 117 may be a separate system from the control module 120 or may be incorporated into the control module 120. In some embodiments, the GUI 117 or other input/output system is coupled to the control module 120 for communicating information between the GUI 117 and the control module 120, such as user confirmation or entry of heating or cooling instructions.

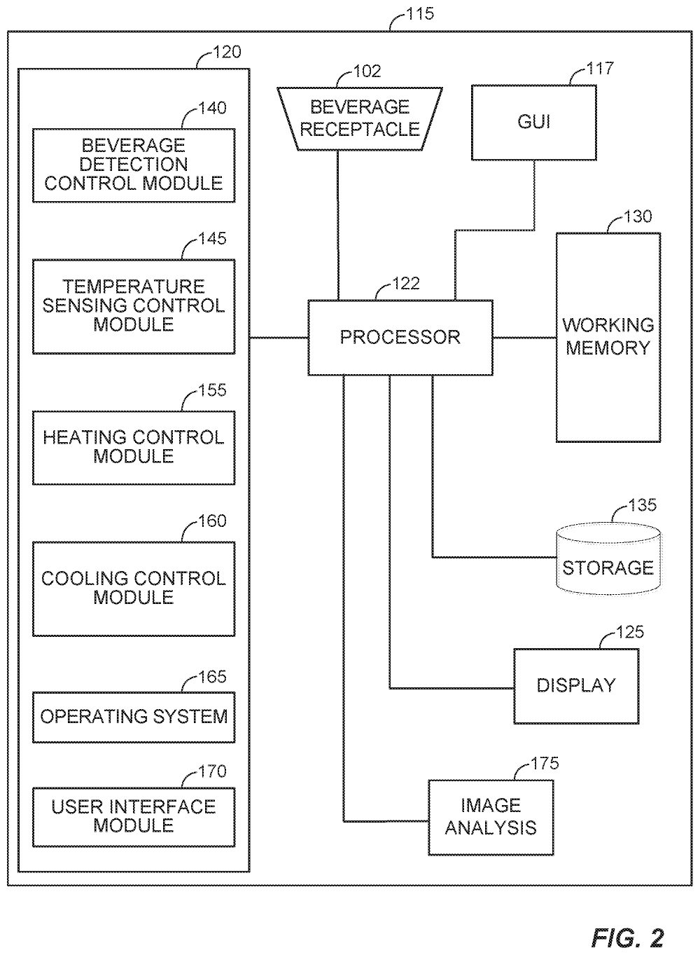

A schematic block diagram of a thermal conditioning system 115 that may be used with a cup holder system 102 is illustrated in FIG. 2. The thermal conditioning system 115 may include additional components that are not illustrated in FIG. 2. For example, additional components incorporated into the system may be omitted from the depicted embodiment for clarity of the illustrated components. As shown, the thermal conditioning system 115 can include a working memory 130, a storage 135, a display or other output 125, a control module 120 and/or the like, a beverage receptacle 102, and a graphical user interface (GUI) 117, one or more of which are operatively coupled to a processor 122.

The thermal conditioning system 115 may be incorporated into an electronic control system for a vehicle. The processor 122 can be a general purpose processing unit or a processor specially designed for in-vehicle applications. As shown schematically in FIG. 2, the processor 122 is operatively coupled to a control module 120 and a working memory 130. In the illustrated embodiment, the control module 120 stores several modules, including a beverage detection control module 140, a temperature sensing control module 145, a heating control module 155, a cooling control module 160, an operating system 165 and user interface module 170. These modules may include instructions that permit the processor 122 to selectively control one or more aspects of the cup holder's operation (e.g., to regulate heating and cooling and device management tasks). In some embodiments, the working memory 130 can be used to store a working set of processor instructions contained in the various modules of the control module 120. In some embodiments, the working memory 130 can be used by the processor 122 to store dynamic data created during the operation of thermal conditioning system 115.

With continued reference to FIG. 2, as mentioned above, the processor 122 can be configured to operate the climate control system of the cup or beverage container system according to one or more schemes or modules of the control module 120. For example, a beverage detection control module 140 can include instructions that configure the processor 122 to control various beverage detection sensors (e.g., pressure sensors, contact switches, etc.) located in, at and/or near the beverage receptacle of the cup holder.

In some embodiments, the temperature sensing control module 145 may include instructions that permit the processor 122 to determine a temperature of a detected beverage positioned within the beverage receptacle. The heating control module 155 and the cooling control module 160 may include instructions that permit the processor 122 to thermally condition (e.g., cool or heat) a beverage positioned within the beverage receptacle. Several embodiments of sensors for beverage detection, sensors for temperature detection of a detected beverage, and thermal conditioning of a detected beverage are disclosed in U.S. patent application Ser. No. 11/669,117, entitled “Cooling System for Container in a Vehicle,” filed on Jan. 30, 2007 and issued as U.S. Pat. No. 8,104,295 on Jan. 31, 2012, which is hereby incorporated by reference in its entirety and included in the attached Appendix.

In some embodiments, a user interface module 170 can include instructions that permit the processor 122 to display information on a display accessible to the user while running the thermal conditioning system 115 (e.g., a touchscreen, another electronic display, etc.). An operating system module 165 can be configured to permit the processor 122 to manage the memory and processing resources of system 115. For example, the operating system module 165 can include device drivers to manage hardware resources such as the electronic display 125. In some embodiments, instructions contained in the thermal processing modules may not interact with these hardware resources directly, but instead may interact through standard subroutines or application programming interfaces (APIs) located in operating system module 165. In such configurations, instructions within the operating system 165 may then interact directly with these hardware components.

In some embodiments, the processor 122 is configured to save data to a storage or storage module 135. While the storage 135 is represented graphically as a traditional drive, multiple embodiments could include either a disk-based storage device or one of several other types of storage mediums, including, without limitation, a memory disk, USB drive, flash drive, remotely connected storage medium, virtual disk driver, or the like.

Although FIG. 2 schematically depicts an example embodiment of a device or system having separate components to include a processor, a beverage receptacle, a GUI, electronic display and control module, such separate components may be combined in a variety of ways to achieve particular design objectives. For example, in an alternative embodiment, the memory components may be combined with processor components to save cost and improve performance. The cup holder system can include any other configuration of components, as desired or required.

Additionally, although FIG. 2 illustrates two memory components, including a working memory 130 and a control module 120, which comprises several modules, different memory architectures can be implemented in various embodiments. For example, a design may utilize ROM or static RAM memory for the storage of processor instructions implementing the modules contained in memory 130. In some embodiments, processor instructions may be read at system startup from a storage device that is integrated into an image analysis system 175 or connected via an external device port. The processor instructions may then be loaded into RAM to facilitate execution by the processor. For example, working memory 130 may be a RAM memory, with instructions loaded into working memory 130 before execution by the processor 122.

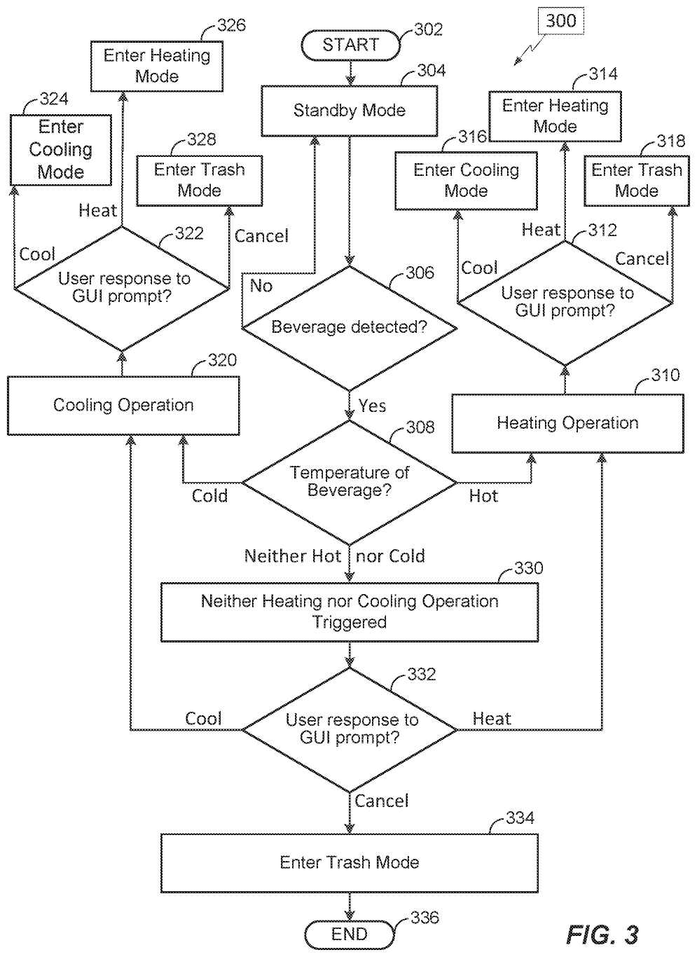

FIG. 3 illustrates a process 300, according to some embodiments, to detect the presence of a beverage within a cup holder and partially or fully automatically determine how to thermally condition the beverage (e.g., whether to heat or cool the beverage), for systems that comprises one or more temperature sensors. Various embodiments may include additional actions not depicted in FIG. 3, and/or only some of the actions or steps illustrated in FIG. 3. In some embodiments, the process 300 may be run on a processor, for example, processor 122 (FIG. 2) and on other components illustrated in FIG. 2 that are stored in memory (e.g., control modules) 120 or that are incorporated in other hardware or software.

With continued reference to the embodiment of FIG. 3, the process 300 begins at start block 302 and transitions to block 304 wherein a standby mode of operation of the heating and/or cooling system is entered. The standby mode may be a default mode of operation for the thermal conditioning system such that the thermal conditioning system remains in the standby mode of operation until a beverage is detected within the cup holder. Process 300 next transitions to block 306 wherein the processor 122 is instructed to check whether a beverage is detected in the cup holder. As noted above, detection of a beverage within the cup holder can be accomplished using any of the embodiments disclosed in U.S. patent application Ser. No. 11/669,117, entitled “Cooling System for Container in a Vehicle,” filed on Jan. 30, 2007 and issued as U.S. Pat. No. 8,104,295 on Jan. 31, 2012, which is hereby incorporated by reference in its entirety. In some embodiments, if a beverage is not detected in the beverage receptacle, the process 300 transitions to block 304 to return to standby mode.

Once a beverage has been detected in the beverage receptacle, process 300 transitions from block 306 to block 308 wherein the temperature of the beverage container is determined. Temperature detection may be accomplished using any of the embodiments discussed in the above-referenced application or by a temperature sensor coupled to the thermal conditioning system 115. If the temperature of the beverage is detected as “hot” or above a predetermined threshold indicating a hot beverage, process 300 transitions to block 310 wherein the processor 122 instructs the heating elements and embodiments of the thermal conditioning system incorporated into the beverage receptacle or cup holder 102 (such as thermoelectric devices or convective heaters) to initiate heating of the beverage.

In some embodiments, once the command to initiate heating is processed, process 300 transitions to block 312 wherein the graphical user interface 117 coupled to the thermal conditioning system prompts the user for confirmation of the heating command. In some embodiments, if the user confirms the heating command in block 312, process 300 transitions to block 314 wherein the system enters a heating mode to selectively heat the beverage within the beverage receptacle of the system using any of the thermal conditioning embodiments, such as any of those disclosed in the above-identified patents and application that are incorporated by reference herein, including, without limitation, thermoelectric devices, convective heaters, other conduction-based heating and/or convection-based heating devices or methods and/or the like.

In various embodiments, control may proceed from block 308 to block 312 to prompt user input before entering one of the heating, cooling, trash or standby modes.

If, instead, the user makes a selection (e.g., a second user input) indicating a preference to cool the beverage, process 300 transitions from block 312 to block 316 wherein the system enters a cooling mode to selectively cool the beverage within the beverage receptacle using any of the thermal conditioning embodiments disclosed in the above-identified patents and application, including, without limitation, thermoelectric devices, other conduction-based cooling and convection-based cooling devices or methods and/or the like.

If, at decision block 312, the user instead makes a selection (e.g., a third user input) to cancel any type of thermal conditioning of the beverage, process 300 transitions to block 318 and the system enters a “trash” mode wherein neither a heating mode nor a cooling mode is triggered and the system awaits further instruction.

In any of the embodiments disclosed herein, a heating or cooling mode does not necessarily mean that the beverage container positioned within the receptacle of the device will be immediately and/or constantly heated or cooled. In other words, according to some embodiments, heating or cooling of a beverage container can occur only after a threshold temperature is reached. Thus, in some embodiments, the thermal conditioning system of the cup holder device or system can be configured to automatically turn on or off (or modulate between different duty cycles) to maintain the temperature of a beverage container at a target temperature or within a target temperature range, as desired or required.

In some embodiments, if the temperature of the detected beverage is cold or the temperature is below a predetermined threshold indicating a cold beverage, process 300 transitions from block 308 to block 320 wherein the processor 122 instructs the heating elements and embodiments of the thermal conditioning system incorporated into the beverage receptacle or cup holder 102 (such as thermoelectric devices or convective heaters) to initiate cooling the beverage. Once the command to initialize cooling is processed, process 300 transitions to block 322 wherein the graphical user interface or other output 117 incorporated within (or operatively coupled to) the thermal conditioning system prompts the user for confirmation of the cooling command. If the user confirms the cooling command in block 322, process 300 transitions to block 324 wherein the system enters a cooling mode to cool the beverage within the beverage receptacle using one or more thermal conditioning embodiments, such as those disclosed in the patent(s) and application(s) incorporated by reference herein, including, without limitation, thermoelectric devices, other conduction-based and/or convection-based cooling devices and/or the like.

In various embodiments, control may proceed from block 308 to block 322 to prompt user input before entering one of the heating, cooling, trash or standby modes.

In some embodiments, if the user instead makes a selection (e.g., a first user input) indicating a preference to heat the beverage, process 300 transitions from block 322 to block 326 wherein the system enters a heating mode to heat the beverage within the beverage receptacle using any of the thermal conditioning embodiments disclosed in the patent(s) and/or application(s) incorporated by reference herein, including, without limitation, thermoelectric devices, convective heaters, other conduction-based and/or convection-based heating devices or methods and/or the like.

If, at decision block 322, the user instead makes a selection (e.g., a third user input) to cancel any type of thermal conditioning of the beverage, process 300 transitions to block 328 and the system enters a “trash” mode wherein neither a heating mode nor a cooling mode is triggered and the system awaits further instruction. The trash mode may correspond to a mode in which the user has finished the beverage and the beverage container rests in the receptacle until the user has an opportunity to discard or store the container in a location other than the receptacle.

According to some embodiments, if the temperature of the detected beverage is neither hot nor cold, that is, the temperature is not at or above the predetermined threshold indicating a hot beverage and the temperature is not at or below the predetermined threshold indicating a cold beverage, the process 300 transitions from block 308 to block 330 wherein the system enters a standby mode to await further instructions or confirmation from the user. The process 300 can then transition to block 332 wherein the graphical user interface system or other output 117 prompts the user to enter an instruction regarding a heating, cooling or cancellation command. If the user provides a heating command by, for example, selecting a heating option on a touchscreen display or pressing a button on a console, the process 300 may, in some embodiments, transition to block 314 to initialize a heating mode of the system and the process 300 continues as discussed above.

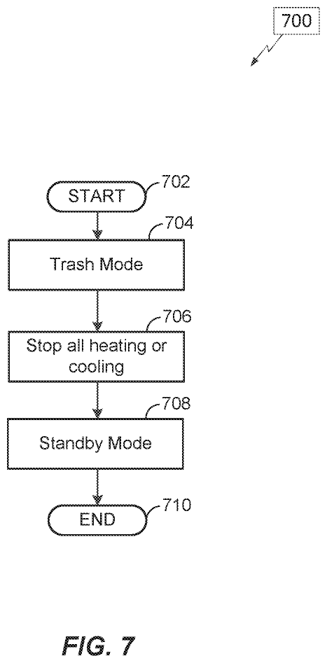

If, however, the user provides a cooling command, the process 300 transitions to block 324 to initialize a cooling mode of the system and the process 300 continues as discussed above. If the user instead indicates a cancellation command, the process 300 can transition to bock 334 wherein the system enters and continues in a “trash” mode as described more fully below with reference to FIG. 7. In various embodiments, the process 300 may transition to block 336 and end after entering the trash mode.

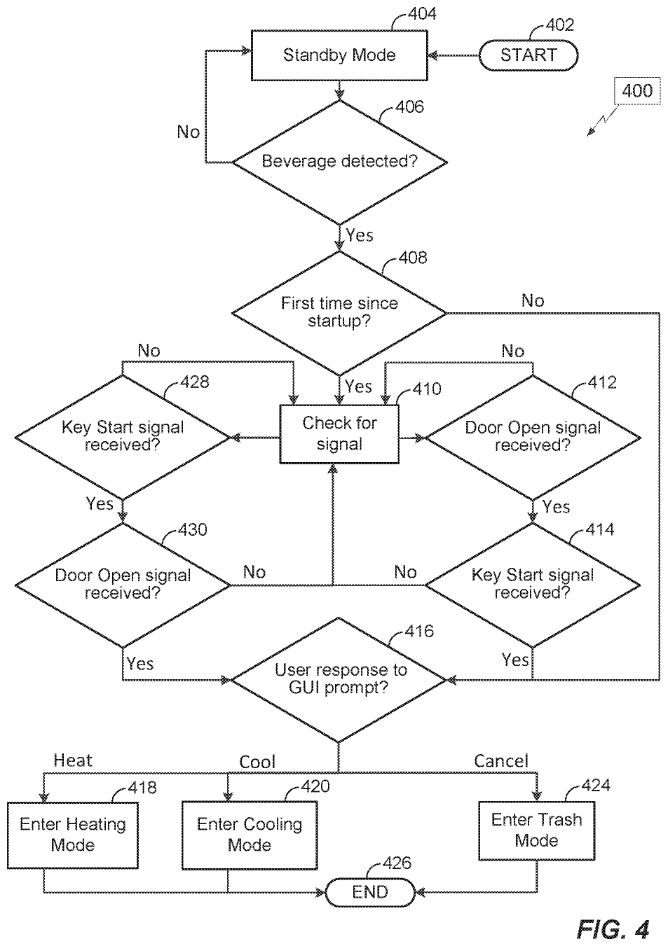

In some embodiments, the system does not include a temperature sensor to measure the temperature of a beverage container positioned within a thermally-conditioned system. With reference to such configurations, FIG. 4 illustrates a process 400, according to some embodiments, to detect the presence of a beverage container within a receptacle of a cup holder and to partially or fully automatically determine how to thermally condition the beverage container (e.g., whether to heat or cool the beverage container). In some embodiments, additional and/or fewer (or different) actions may be included in a control method that are not depicted in FIG. 4. In some configurations, the process 400 may be run on a processor, for example, processor 122 (FIG. 2) and on other components illustrated in FIG. 2 that are stored in memory (e.g., control modules) 120 and/or that are otherwise incorporated in other hardware or software of the system.

According to some embodiments, the process 400 begins at start block 402 and transitions to block 404 wherein a standby mode of operation of the thermal conditioning system is entered. The standby mode may be a default mode of operation for the thermal conditioning system such that the thermal conditioning system remains in the standby mode of operation until a beverage container is detected within a receptacle of the cup holder or the user initiates the system 115 using the graphical user interface 117. Process 400 can next transition to block 406 wherein the processor 122 is instructed to determine whether a beverage container is detected in the receptacle. As discussed herein, detection of a beverage container within the receptacle may be accomplished using any of the embodiments disclosed in the patent(s) and application(s) incorporated by reference. If a beverage container is not detected in the receptacle of the device, the process 400 can transition to block 404 to return to a standby mode of operation.

According to some embodiments, once a beverage has been detected in the beverage receptacle, process 400 transitions from block 406 to block 408 wherein the processor 122 determines whether the detection of the beverage container is the first detection that has occurred since startup of the thermal conditioning system, such as the startup of the vehicle in which the cup holder is positioned.

In some embodiments, if the detection event is the first detection event since startup, process 400 transitions to block 410 wherein the processor 122 is instructed to check for signals, such as, for example, detection of a key within the ignition, a key on or key start signal, a door open signal of a vehicle and/or the like. By checking one or more of these signals, the processor 122 can determine whether a user has recently entered the vehicle with a beverage, and distinguish between a new beverage container entering the receptacle and a beverage container that the user left in the receptacle the last time the user exited the vehicle.

Process 400 can then transition to separate and parallel processes. In some embodiments, along one branch, process 400 transitions to decision block 412 wherein the processor 122 is instructed to determine whether a door open signal (or other comparable signal) has been received. For example, such a signal can indicate that one or more of the vehicle's doors are open. If a door open signal has not been received, for instance, the process 400 can transition back to decision block 410 to check for additional signals.

In some embodiments, if a door open signal (or a comparable signal) has been received, the process 400 transitions to decision block 414 wherein the processor 122 is instructed to determine whether a key start signal has also been received. If a key start signal is not confirmed as received in decision block 414, the process 400 can transition to block 410 to further check for signals.

In some embodiments, if a key start signal has been received, the process 400 transitions to decision block 416 wherein an output device, such as the graphical user interface 117 in communication with the control module of the thermal conditioning system, prompts the user to select between a heating, cooling, cancel and/or other command. For example, if the user selects a heating command, process 400 transitions to block 418 wherein the system enters a heating mode to selectively (but not necessarily constantly) heat the beverage within the beverage receptacle. As discussed, the heating can be performed based on certain threshold values; thus, the heating of the beverage container can occur once the detected temperature of the beverage container (e.g., as measured by one or more temperature sensors) drops below a particular threshold level.

In some embodiments, if the user instead makes a selection indicating a preference to cool the beverage container, process 400 transitions from block 416 to block 420 wherein the system enters a cooling mode to cool the beverage within the beverage receptacle. If the user instead makes a selection to cancel any type of thermal conditioning of the beverage at decision block 416, the process 400 transitions to block 424 and the system enters a “trash” mode wherein neither a heating mode nor a cooling mode is triggered and the system awaits further instruction from the user.

If a signal is initially detected in block 410, the process 400 will, simultaneously (or in parallel) with the transition to block 412, transition to block 428 to determine whether a key start signal or other initiating event signal has been received. In some embodiments, if a key start signal (or other initiating event signal), the process 400 can transition to block 410 to further check for signals.

According to some embodiments, if the signal received by the system is a key start signal, the process 400 transitions to block 430 wherein the system determines if a door open signal (and/or some other comparable signal) has also been received. If a door open signal (and/or some other comparable signal) is not confirmed as received in decision block 430, the process 400 can transition to block 410 to further check for signals.

In some embodiments, if a door open signal has also been received, the process 400 transitions to decision block 416 wherein a graphical user interface or other output, such as the graphical user interface 117 incorporated within and/or operatively coupled to the thermal conditioning system, prompts the user for a heating, cooling, cancel and/or other command.

In some embodiments, if the user provides a heating command, process 400 transitions to block 418 wherein the system enters a heating mode to selectively heat the beverage within the beverage receptacle using any of the thermal conditioning embodiments disclosed herein and/or the patents and application incorporated by reference herein. In some embodiments, the process 400 then transitions to block 426 and ends.

If the user instead makes a selection indicating a preference to cool the beverage, process 400 transitions from block 416 to block 420 wherein the system enters a cooling mode to cool the beverage within the beverage receptacle. The process 400 can then transition to block 426 and ends after entering one of the heating, cooling or trash modes.

According to some embodiments, if the user instead makes a selection to cancel any type of thermal conditioning of the beverage at decision block 416, the process 400 transitions to block 424 and the system enters a “trash” mode wherein neither a heating mode nor a cooling mode is triggered and the system awaits further instruction. The process 400 can then transition to block 426 and end.

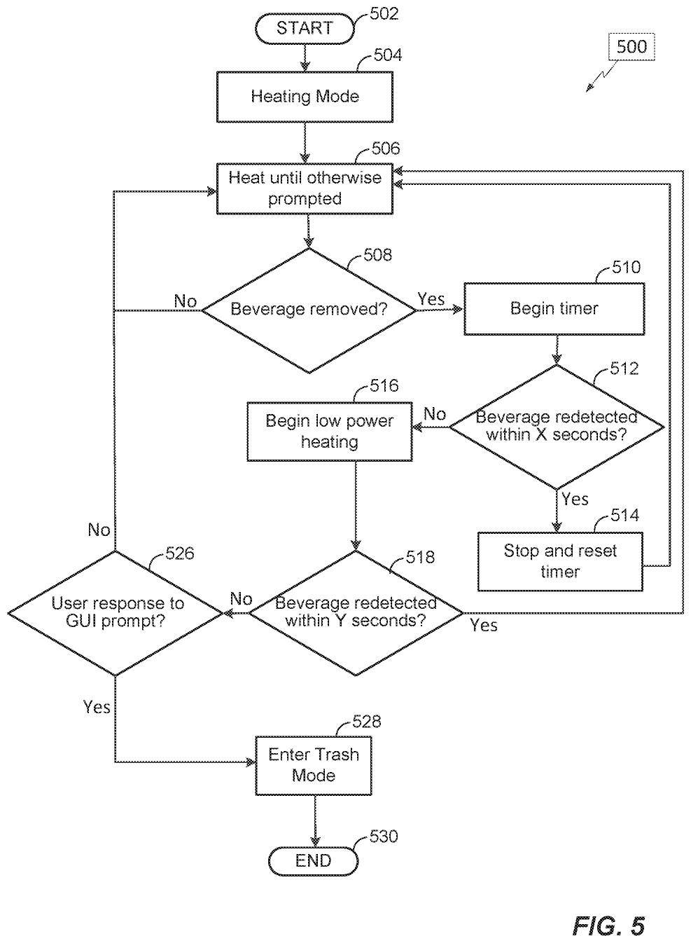

FIG. 5 illustrates a process 500, according to some embodiments, for detecting a beverage container within a beverage receptacle of a cup holder and partially or fully automatically determine how to thermally condition (e.g., heat or cool) the beverage container. For example, the system can determine whether to heat or cool the beverage container based on an amount of time a beverage container is detected or not detected within the receptacle. Various embodiments may include additional, fewer and/or different actions than those schematically depicted in FIG. 5. In some examples, the process 500 may be operated on a processor, for example, processor 122 (FIG. 2) and on other components, as schematically illustrated in FIG. 2. The process 500 may be continuation of any of the processes discussed herein wherein a heating mode is selected.

According to some embodiments, the process 500 begins at start block 502 and transitions to block 504 wherein a heating mode of operation of the thermal conditioning system is entered. Next, if a beverage container is detected in the beverage receptacle of the cup holder system, the process 500 transitions to block 506 wherein the heating control module initiates a normal heating operation to selectively (e.g., but not necessarily continuously and/or immediately) provide heat at a first predetermined level to the beverage receptacle until otherwise prompted or entering low power heating at a second predetermined level less than the first predetermined level. The process 500 can then transition to block 508, wherein the processor 122 is instructed to determine whether a beverage container has been removed from the beverage receptacle of the thermal conditioning system using any of the embodiments for detection disclosed herein and/or in the patent(s) and application(s) incorporated by reference herein (e.g., pressure sensors, temperature sensors, etc.).

In some embodiments, if the system 115 detects that a beverage container is removed from the receptacle of the cup holder device or system, the process 500 transitions to block 510 wherein a timer is started. The process 500 then transitions to block 512 wherein the system determines whether a beverage has been redetected within the receptacle within a predetermined period X, wherein X is a real number greater than or equal to zero. In some embodiments, the predetermined period X can be greater than zero seconds and less than or equal to 1 second (i.e. 0<X<=1 sec) to avoid prolonged periods a hot surface of the receptacle is exposed to nearby persons while the user consumes the beverage and/or conserve power.

In some embodiments, the predetermined period X can be greater than one (1) second and less than or equal to ten (10) seconds (i.e. 1<X<=10 sec) to avoid entering a low power heating mode during a relatively brief period before the user returns the beverage container to the receptacle after taking a single sip or drink from the beverage.

In some embodiments, the predetermined period X can be greater than ten (10) seconds and less than an estimated time the user will keep the beverage container away from the receptacle while consuming from it, for example two (2) to five (5) minutes or more or five (5) to ten (10) minutes or more. If the beverage is redetected in the receptacle within the predetermined period X, the process 500 transitions to block 514 and the timer is stopped and reset to zero. From block 514, the process 500 transitions to block 506 wherein the heating elements are instructed to continue to provide heat to the receptacle.

If the beverage is not redetected in the receptacle within the predetermined period X, the process 500 transitions to block 516 wherein the heating elements are instructed by the heating control module to operate in a low power heating mode. The low power heating mode may provide a lower amount of heating to the receptacle than the normal heating mode, thereby conserving energy and reducing a temperature of the hot surfaces of the receptacle. The process 500 then transitions to block 518 wherein the system determines whether a beverage has been redetected within a second predetermined period Y, wherein Y is a real number greater than or equal to zero and is greater than the first predetermined period X (i.e. Y>X). The predetermined period Y can correspond to a predetermined maximum power consumption, and can be based on an estimated time for the user to finish consuming the beverage. In some embodiments, the predetermined period Y can be a period of five (5) to ten (10) minutes or more. In other embodiments, the predetermined period Y may be between two (2) to five (5) minutes or more.

In some embodiments, if a beverage is not redetected within the predetermined period Y, the process 500 transitions to block 526 wherein the graphical user interface prompts the user to indicate whether the user wants to terminate the heating mode. If the user confirms the termination request, the process 500 transitions to block 528 wherein the system enters a “trash” mode as described more fully below with reference to FIG. 7. In some embodiments, the process 500 subsequently transitions to block 530 and ends after entering the trash mode. If the user does not confirm the termination request, the process 500 can transition to block 506 to continue to provide heat to the receptacle, and the process 500 can proceed as discussed above.

According to some embodiments, if, at block 518, a beverage container is redetected in the receptacle within the predetermined period Y, the process 500 transitions to block 506 to continue to provide heat to the receptacle, and the process 500 can proceed as discussed above.

While FIG. 5 schematically illustrates a process for operating a heating mode for thermally conditioning a beverage container detected within a beverage receptacle, the process 500 may also be applied to control a cooling mode for cooling a detected beverage within a beverage receptacle.

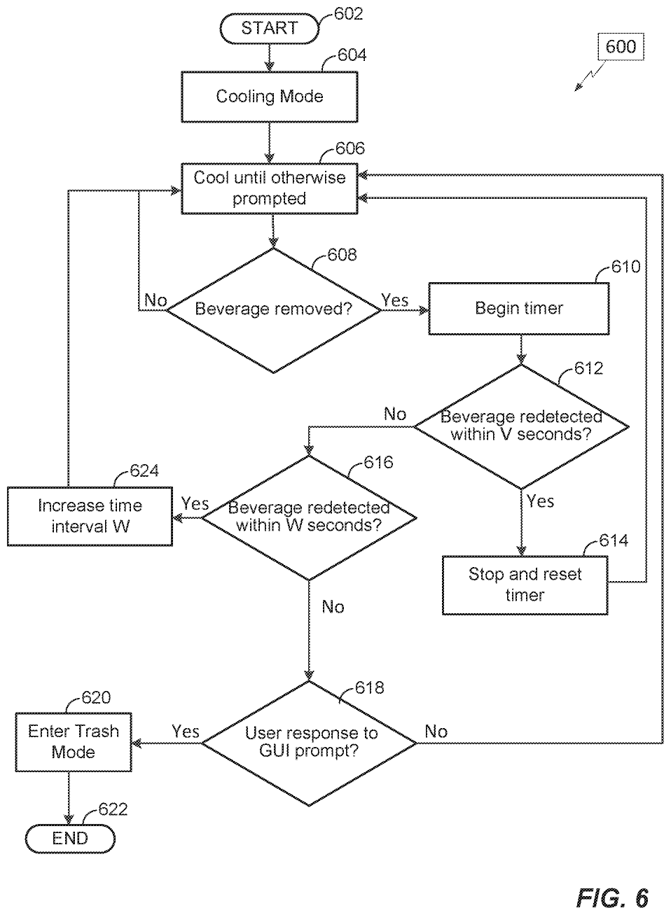

FIG. 6 schematically illustrates another embodiment of a process 600 to detect a beverage container within a receptacle of a cup holder and partially or fully automatically determine how to thermally condition the beverage, for example, whether to selectively cool the beverage container based on an amount of time a beverage container is detected or not detected within the receptacle. Various embodiments may include additional, fewer and/or different actions than those included in FIG. 6. In some examples, the process 600 may be run on a processor, for example, processor 122 (FIG. 2) and on other components illustrated in FIG. 2 that are stored in memory (e.g., control modules) 120 and/or that are incorporated in other hardware or software. The process 600 may be a continuation of any of the processes discussed above wherein a cooling mode is entered.

In some embodiments, the process 600 begins at start block 602 and transitions to block 604, wherein a cooling mode of operation of the thermal conditioning system is entered. Process 600 can then transition to block 606 wherein the cooling control module removes heat or cools the receptacle of the cup holder device or system until otherwise prompted. The process 600 can then transition to block 608, wherein the beverage detection control module of the system 115 determines whether a beverage container has been removed from the beverage receptacle. In some embodiments, any of the embodiments for detection of a beverage container discussed in the patent(s) and application(s) incorporated by reference herein are used. If a beverage container is detected in the receptacle, the process 600 can transition to block 606 to continue cooling the receptacle.

However, in some embodiments, if the system 115 detects that a beverage container has been removed, the process 600 transitions to block 610 wherein a timer is started. The process 600 can then transition to block 612, wherein the system determines whether a beverage container has been redetected within the receptacle within a predetermined period V, wherein V is a real number greater than or equal to zero. In some embodiments, the predetermined period V is greater than an estimated period during which the user is taking a single sip or drink from the beverage container and/or less than an estimated period the user has finished consuming the beverage and placed or discarded the beverage container in a location other than the receptacle. The predetermined period V can correspond to a predetermined maximum power consumption. In some embodiments, the predetermined period V can be a period of two (2) to five (5) minutes or more. If the beverage is redetected in the receptacle within the predetermined period V, the process 600 can transition to block 614 and the timer can be stopped and reset to zero. In some embodiments, the process 600 then transitions to block 606 wherein the cooling elements are instructed to continue to cool the receptacle.

According to some embodiments, at block 612, if the beverage container is not redetected in the receptacle within the predetermined period V, the process 600 transitions to block 616. At block 616, the system determines whether a beverage container has been redetected within a second predetermined period W, wherein W is a real number greater than zero, and in some embodiments, is greater than the first predetermined period V (i.e. W>V). The predetermined period W can correspond to a predetermined maximum power consumption, and can be based on an estimated time for the user to finish consuming the beverage. In some embodiments, the predetermined period W can be a period of five (5) to ten (10) minutes or more.

In some embodiments, if a beverage container is not redetected within the predetermined period W, the process 600 transitions to block 618 wherein the graphical user interface or other output, such as the graphical user interface 117 coupled to the thermal conditioning system, prompts the user to indicate whether the user wants to terminate the cooling mode of the system. If the user confirms the termination request, the process 600 transitions to block 620 wherein the system enters a trash mode as described more fully below with reference to FIG. 7. The process 600 can then transition to block 622 and end after entering the trash mode. If the user does not confirm the termination request or indicates that termination of the cooling process is not desired, the process 600 transitions to block 606 to continue to cool the receptacle and the process 600 proceeds as discussed above.

In some embodiments, if, at block 616, a beverage container is redetected in the receptacle within the predetermined period W, the process 600 can transition to block 624 wherein the system 115 increases the predetermined period V by a predetermined amount. In some embodiments the predetermined amount can be an amount equal to a difference D equal to an elapsed period EP since beginning the timer at block 610 minus the predetermined period V (i.e. D=EP−V), wherein D and EP are real numbers greater than zero. In other embodiments, the amount can be product P equal to a predetermined fraction F multiplied by the elapsed time (i.e. P=F*EP), wherein P is a real number and F is a real number greater than zero and less than or equal to one. In some embodiments, the process 600 then transitions to block 606, wherein the cooling elements are instructed to continue to cool the receptacle and the process 600 continues as discussed above.

While FIG. 6 schematically illustrates a process for operating a cooling mode for thermally conditioning a beverage container within a beverage receptacle, the process 600 may also be applied in a similar manner to control a heating mode for heating a detected beverage container within a receptacle of the thermally conditioned cup holder device or system. Additionally or alternatively, control aspects of the process 500 described above, such as but not limited to entering a low power mode of operation during prolonged periods when a beverage is not detected.

A process for operation of a thermal conditioning system in a “trash” mode wherein heat is removed from the thermally-conditioned beverage receptacle without an active cooling operation is schematically illustrated in FIG. 7. The system operates in a trash mode when the user has finished drinking the beverage and has placed the beverage container back in the receptacle for storage until the user can remove the beverage container from the receptacle and dispose of the container in the garbage or store the container in a location other than the receptacle. Various embodiments may include additional, fewer and/or different actions or steps included in FIG. 7, as desired or required. For instance, in some examples, the process 700 may be operated on a processor, e.g., the processor 122 schematically illustrated in FIG. 2, and/or on other components illustrated in FIG. 2 that are stored in memory (e.g., control modules) 120 or that are incorporated in other hardware or software. The process 700 may be a continuation of any of the processes discussed above wherein a “trash” mode is entered.

With continued reference to the embodiment schematically depicted in FIG. 7, the process 700 can begin at start block 702 and transition to block 704, such that the system is operated in a “trash” mode. The process 700 can next transition to block 706 wherein all heating and cooling operations are stopped to conserve energy and/or prevent unintentional contact with a hot or cold receptacle. In some embodiments, the process then transitions to block 708 where the thermal conditioning system enters a standby mode where control may proceed according to the process 300 described above. The process 700 can then transition to block 710 and end. In some embodiments, the removal of a beverage container from the receptacle of the device or system when the thermal conditioning system is in a “trash” mode may also trigger operation of the system in a standby mode.

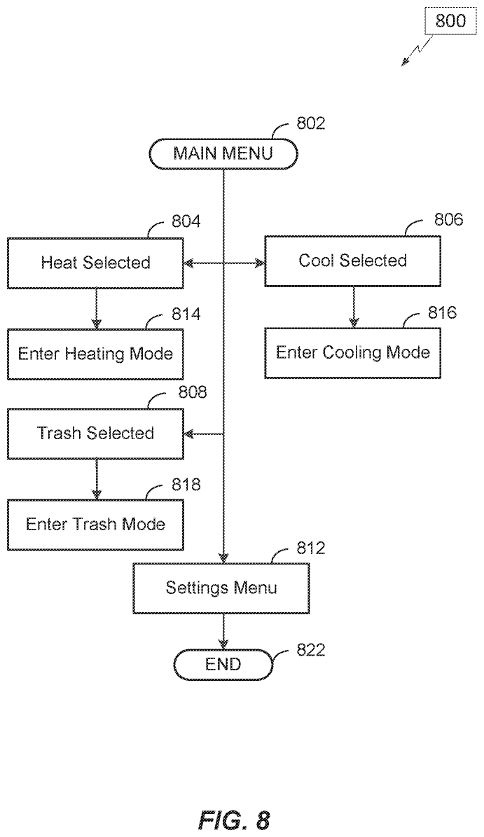

A menu tree 800 of user-selectable options for a graphical user interface for a thermal conditioning system is schematically illustrated in FIG. 8. By way of example, from a main menu 802, the user can select from a plurality of options for operation of the thermal conditioning system, including heating operation 804, a cooling operation 806, a “trash” mode of operation 808, a settings menu 812 and/or any other mode, as desired. If, for example, the user selects a heating operation 804, the thermal conditioning system operates in a heating mode 814 according to any of the control embodiments discussed herein.

Alternatively, if the user selects a cooling operation 806, the thermal conditioning system operates in a cooling mode 816 according to any of the control embodiments discussed herein. Further, if the user selects a “trash” mode of operation 808, the thermal conditioning system operates in such a “trash” or termination mode 818, in accordance with any of the control embodiments discussed herein.

Likewise, if the user selects a settings menu or option 812, the graphical user interface or other output displays a settings menu 812 for the user to adjust operational settings of the thermal conditioning system. The menu tree 800 may end 822 after settings menu 812. These settings may include, but are not necessarily limited to, a desired heating temperature, elapsed time intervals used in heating or cooling operations, such as the intervals disclosed herein and/or the like.

In some embodiments, the graphical user interface or other user output may comprise a display incorporated into the console of a vehicle and/or any other system or component, as desired or required (e.g., a separate system of the vehicle, a dedicated display for the cup holder or receptacle, a smartphone, tablet or other secondary device with which the user can interface, etc.). In other embodiments, the graphical user interface may be incorporated into and unitary with the thermal conditioning system. However, such a user interface or other output can be separate of the vehicle, the thermal conditioning system and/or the cup holder or receptacle, as desired or required.

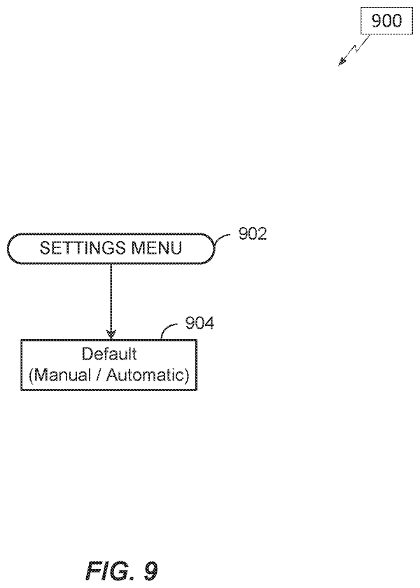

For thermal conditioning systems that include a temperature sensor, FIG. 9 schematically illustrates a settings menu tree 900, according to some embodiments, that displays selectable settings on a graphical user interface or other display or output. The settings menu 902 can include a selection for a default mode of operation 904 using a temperature sensor. The default mode of operation 904 may include, for example, a manual input of temperature settings, the use of predetermined temperature settings and/or the like.

Although several embodiments and examples are disclosed herein, the present application extends beyond the specifically disclosed embodiments to other alternative embodiments and/or uses of the inventions and modifications and equivalents thereof. It is also contemplated that various combinations or subcombinations of the specific features and aspects of the embodiments may be made and still fall within the scope of the inventions. Accordingly, it should be understood that various features and aspects of the disclosed embodiments can be combine with or substituted for one another in order to form varying modes of the disclosed inventions. Thus, it is intended that the scope of the present inventions herein disclosed should not be limited by the particular disclosed embodiments described above, but should be determined only by a fair reading of the claims that follow.

While the inventions are susceptible to various modifications, and alternative forms, specific examples thereof have been shown in the drawings and are herein described in detail. It should be understood, however, that the inventions are not to be limited to the particular forms or methods disclosed, but, to the contrary, the inventions are to cover all modifications, equivalents, and alternatives falling within the spirit and scope of the various embodiments described and the appended claims. Any methods disclosed herein need not be performed in the order recited.

1. A system for controlling operation of a thermally-conditioned receptacle, the system comprising:
a control module configured to:
detect an item within the receptacle;
measure a temperature of the item within the receptacle;
initiate a heating mode of operation in response to the measured temperature or a first user input;
initiate a cooling mode of operation in response to the measured temperature or a second user input; and
cancel the heating mode and the cooling mode of operation in response to a third user input,
wherein the control module is further configured to determine whether detecting the item within the receptacle is a first detection of an item within the receptacle since a start up condition or the item was left within the receptacle before the start up condition.

2. (canceled)

3. The system of claim 1, wherein the control module is further configured to detect a door open signal and a key start signal and initiate the heating mode of operation in response to detection of the key start signal and the door open signal.

4. A system according to claim 1, wherein initiating a heating mode of operation further comprises heating.

5. A system according to claim 1,
wherein the control module is further configured to detect a door open signal and a key start signal and initiate the cooling mode of operation in response to detection of the key start signal and the door open signal.

6. A system according to claim 1, further comprising a graphical user interface configured to display cooling or heating mode of operation information to a user and accept the user inputs regarding cancellation or operation of the heating or cooling mode of operation.

7. A method for controlling operation of a thermally-conditioned receptacle, the method comprising:
detecting an item within the receptacle;
measuring a temperature of the item within the receptacle;
accepting and storing a user input on a mode of operation;
initiating a heating mode of operation or a cooling mode of operation in response to the measured temperature or the user input; and
prompting a user confirmation of the initiated mode of operation,
wherein initiating a heating mode of operation further comprises detecting whether an item has been removed from the receptacle, starting a timer, determining whether the item is redetected in the receptacle within a first time limit and when the item is redetected in the receptacle within the first time limit, resetting the timer and continuing to operate in the heating mode until otherwise prompted, and when the item is not redetected in the receptacle within the first time limit, initiating operation in a low power heating mode of operation.

8. (canceled)

9. (canceled)

10. The method of claim 7, wherein initiating a heating mode of operation further comprises detecting whether the item is redetected within the receptacle within a second time limit that is longer than the first time limit and prompting a user for confirmation or cancellation of the heating mode of operation.

11. A method according to claim 7, further comprising operating the cooling mode for a predetermined time limit, measuring the temperature of the item after the predetermined time limit, determining whether the temperature of the item is above or below a predetermined temperature, displaying a message to a user if the temperature is below the predetermined temperature, and continuing operation of the cooling mode if the temperature is not below the predetermined temperature.

12. (canceled)

13. (canceled)

14. (canceled)

15. A method for controlling operation of a thermally-conditioned receptacle, the method comprising:
detecting an item within the receptacle;
receiving a first signal indicative of a door open condition;
receiving a second signal indicative of a key start condition;
accepting and storing a user input on a mode of operation;
initiating a heating mode of operation or a cooling mode of operation in response to the first signal, the second signal, or the user input; and
prompting a user confirmation of the initiated mode of operation,
wherein initiating a heating mode of operation further comprises detecting whether an item has been removed from the receptacle, starting a timer, determining whether the item is redetected in the receptacle within a first time limit and when the item is redetected in the receptacle within the first time limit, resetting the timer and continuing to operate in a heating mode until otherwise prompted, and when the item is not redetected in the receptacle within the first time limit, initiating operation in a low power heating mode of operation.

16. (canceled)

17. The method of claim 15, wherein initiating a heating mode of operation further comprises detecting whether the item is redetected within the receptacle within a second time limit that is longer than the first time limit and prompting a user for confirmation or cancellation of the heating mode of operation.

18. A method according to claim 15, further comprising:
operating the cooling mode for a predetermined time limit,
measuring the temperature of the item after the predetermined time limit,
determining whether the temperature of the item is above or below a predetermined temperature,
displaying a message to a user if the temperature is below the predetermined temperature, and
continuing operation of the cooling mode if the temperature is not below the predetermined temperature.

19. (canceled)

20. (canceled)
